(19) United States
(12) Patent Application Publication
(10) Pub. No.: US 2009/0256035 A1
(43) Pub. Date: Oct. 15, 2009

(54) Instrument-mounting head with balance control

(76) Inventor: Thomas McKay, Austin, TX (US)

Correspondence Address: JACOBSON HOLMAN PLLC, 400 SEVENTH STREET N.W., SUITE 600, WASHINGTON, DC, 20004, US

(21) Appl. No.: 12/285,805

(22) Filed: Oct. 14, 2008

Related U.S. Application Data
(63) Continuation-in-part of application No. 29/300,564, filed on Apr. 10, 2008, now Pat. No. D594499.

(51) Int. Cl. F16M 11/24

(52) U.S. Cl. 248/179.1

(57) ABSTRACT

A head for mounting a camera or other instrument on a tripod or jib, which includes an elongated base plate mountable on a tripod or a jib for a panning motion, a support column extending vertically from the top surface of the base plate, a carrier arm having a longitudinal axis extending between its first and second ends and being pivotably mounted at its first end to the top of the support column, an instrument platform movably mounted on the carrier arm, and a tilt mechanism operatively connected to the instrument platform for both gross and fine control of the tilt of the instrument platform. The tilt mechanism includes a conventional pan and tilt handle attached to a rotatable tilt shaft and a belt-driven, fine control mechanism mounted to the support column and operatively connected to the tilt shaft.

### CROSS-REFERENCE TO RELATED APPLICATIONS

The present patent application is related to application Ser. No. ______ (Atty Docket P72572US1), filed Aug. 21, 2008, and entitled “CAMERA-MOUNTING HEAD WITH BALANCE CONTROL,” which is a continuation-in-part of application Ser. No. 29/300,564, filed Apr. 10, 2008, both of which are incorporated herein by reference in their entireties; and is also related to application Ser. No. 29/309,476, filed Aug. 21, 2008, and which is also incorporated herein by reference in its entirety.

### COPYRIGHTED MATERIAL

Not applicable.

### BACKGROUND OF THE INVENTION

1. Field of the Invention

The present invention relates to a head for mounting a camera or other instrument on a tripod or jib. More specifically, the invention relates to such a head, which an instrument operator can use to exactly balance the instrument's center of gravity.

2. Related Art

U.S. Pat. Nos. 1,894,456, 2,514,313, 4,249,817, 4,621,785, 5,497,214, 5,725,187, 5,752,113, and 6,698,942 all disclose different types of heads for mounting cameras on tripods, and for pivoting and/or panning the mounted camera.

Although conventional tripod heads allow a user to pan and tilt a camera or other instrument (such as a telescope) mounted thereon, they provide limited options for balancing the instrument's center of gravity, and such options as they do provide prevent the user from adjusting the instrument's pan and tilt without having to tighten the drag control.

It is to the solution of these and other problems that the present invention is directed.

### SUMMARY OF THE INVENTION

It is accordingly a primary object of the present invention to provide a head that can be used for mounting a camera or other instrument on either a tripod or a jib, and which allows fine control of the tilt mechanism of the instrument mounting head.

It is still another object of the present invention to provide a tripod or jib-mounted head that allows a user to exactly balance the instrument's center of gravity while providing fine control of the tilt mechanism of the instrument mounting head.

These and other objects are achieved by a head for mounting a camera or other instrument on a tripod or jib, which includes an elongated base plate mountable on a tripod or a jib for a panning motion, a support column extending vertically from the top surface of the base plate, a carrier arm having a longitudinal axis extending between its first and second ends and being pivotably mounted at its first end to the top of the support column, an instrument platform movably mounted on the carrier arm, and a tilt mechanism operatively connected to the instrument platform for both gross and fine control of the tilt of the instrument platform. The tilt mechanism includes a conventional pan and tilt handle attached to a rotatable tilt shaft and a belt-driven, fine control mechanism mounted to the support column and operatively connected to the tilt shaft.

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 is a front perspective view showing the instrument-mounting head with balance control, in accordance with the present invention, with the instrument platform tilted in a horizontal plane.

FIG. 2 is a right side elevational view of the instrument-mounting head of FIG. 1.

FIG. 3 is a front elevational view of the instrument-mounting head of FIG. 1.

FIG. 4 is a left side elevational view of the instrument-mounting head of FIG. 1.

FIG. 5 is a back elevational view of the instrument-mounting head of FIG. 1.

FIG. 6 is a top plan view of the instrument-mounting head of FIG. 1.

FIG. 7 is a bottom plan view of the instrument-mounting head of FIG. 1.

FIG. 8 is a right side elevational view of the instrument-mounting head of FIG. 1, with the instrument platform tilted in a vertical plane.

FIGS. 9a-9c are back elevational views of the instrument-mounting head of FIG. 1, showing a camera mounted on the instrument platform, with the instrument platform tilted in a vertical plane, a horizontal plane, and a plane at approximately 45° to the horizontal, respectively.

FIGS. 10a-10d are bottom plan views of the instrument-mounting head of FIG. 1, with the base plate shown partially broken away, illustrating the panning motion of the instrument-mounting head in the direction of the arrows.

FIG. 11 is a right side elevational view of the instrument-mounting head of FIG. 1, showing the pan and tilt handle mounted on the drive knob of the fine control mechanism.

FIG. 12 is a back elevational view of the instrument-mounting head of FIG. 1, showing the pan and tilt handle mounted on the drive knob of the fine control mechanism.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

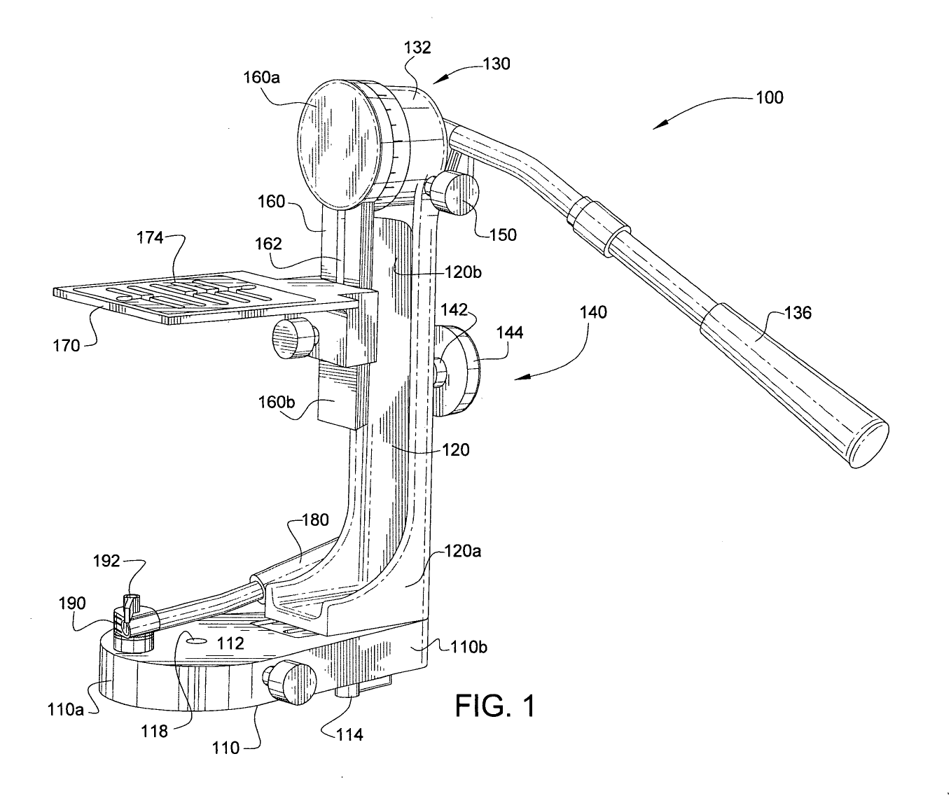

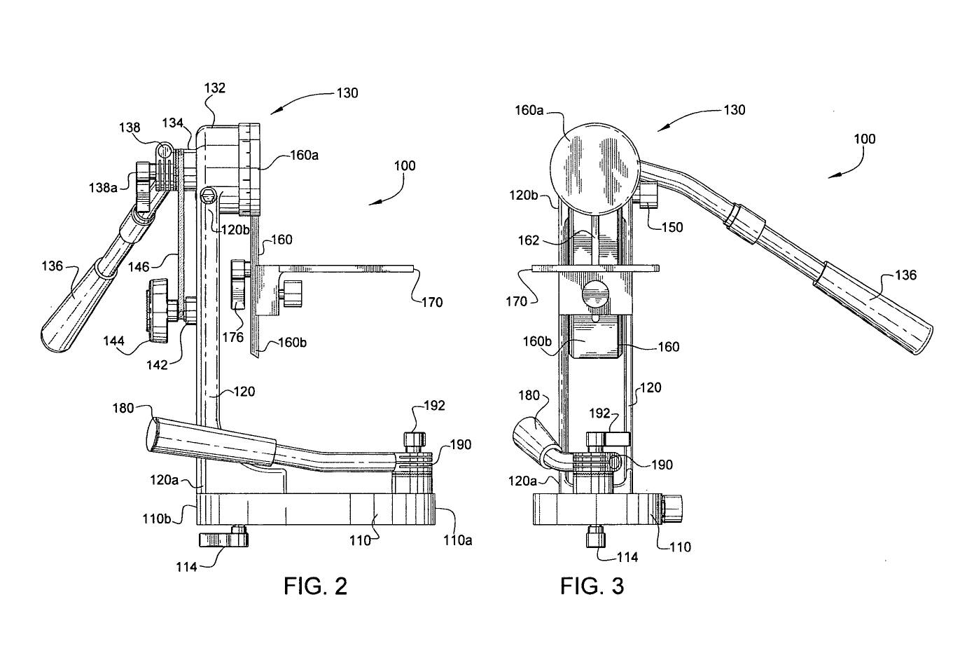

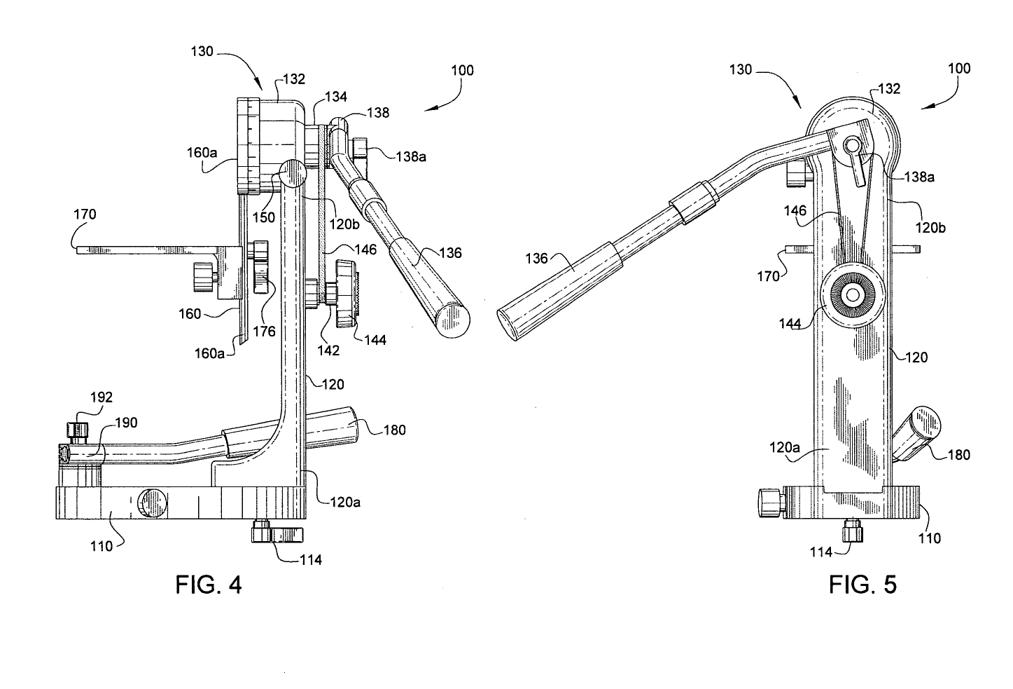

Referring now to FIGS. 1-8, an instrument-mounting head 100 in accordance with the present invention, for mounting an instrument such as a instrument 10 on a tripod or jib (not shown), comprises an elongated base plate 110 having first and second ends 110a and 110b and a support column 120 extending vertically from the top surface of the base plate 110 at the second end 110b, the support column 120 having a first end 120a attached to the base plate 110 and a second end 120b remote from the base plate 110. The base plate 110 can be provided with a level 118, for example set into its top surface, for use in aligning the head 100 relative to a horizontal plane. A tripod or jib mount (not shown) can be attached to the bottom surface of the base plate 110 at the front end for pivotably mounting the head 100 to a tripod or a jib.

A pan and tilt mechanism is provided at the free end 120a of the support column 120. As discussed in greater detail hereinafter, the pan and tilt mechanism combines the features of a conventional pan and tilt handle unit 130 (for example, as disclosed in U.S. Pat. No. 2,514,313 to Davidson et al. or as taught in U.S. Pat. No. 4,621,785 to Embra) with a belt-driven, fine control mechanism 140.

A carrier arm 160 having first and second ends 160a and 160b is fixedly mounted to the pan and tilt handle unit 130 at its first end 160a, as discussed in greater detail hereinafter; and an instrument platform 170 is movably mounted on the carrier arm 160. An auxiliary handle 180 is provided on the base plate 110 for pivoting the head 100 relative to the tripod or jib when the camera or other instrument is tilted with its lens directed either up or down, as will be described in greater detail hereinafter.

The pan and tilt handle unit 130 includes a stationary tilt casing 132 on the free end of the support column 120, a tilt shaft 134 rotatable in the tilt casing 132a, a pan and tilt handle 136 removably attached to a first end of the tilt shaft 134 via a pan and tilt handle socket 138, and a socket lever 138 for selectively locking the pan and tilt handle 136 in the pan and tilt handle socket 138. The tilt casing 132 can be formed unitarily with the support column 120 as best shown in FIGS. 1, 2, 4, 5, 8, and 9a-9c, or can be a separate piece attached to the free end of the support column 120. A conventional locking drag control 150 is provided in the tilt casing 132 for adjusting the tilting drag and locking the tilt shaft 134.

The pan and tilt handle 136, pan and tilt handle socket 138, and socket lever 138 can be conventional, as taught in U.S. Pat. No. 4,621,785, the disclosure of which is incorporated herein by reference. In such a construction, when the socket lever 138 is partially loosened, the tilt socket 138 can be rotated around the tilt shaft 134, in order to adjust the position of the pan and tilt handle 136 relative to axis of the tilt shaft 134.

The belt-driven, fine control mechanism 140 includes a rotatable drive shaft 142 mounted to the back of the support column 120 below and offset from the tilt shaft 134, a drive knob 144 mounted at the end of the drive shaft 142 for rotation therewith, and a drive belt 146 extending between the tilt shaft 134 and the drive shaft 142. The diameter of the drive shaft 142 is smaller than that of the tilt shaft 134, so that turning of the drive knob 144 finely controls rotation of the tilt shaft 134.

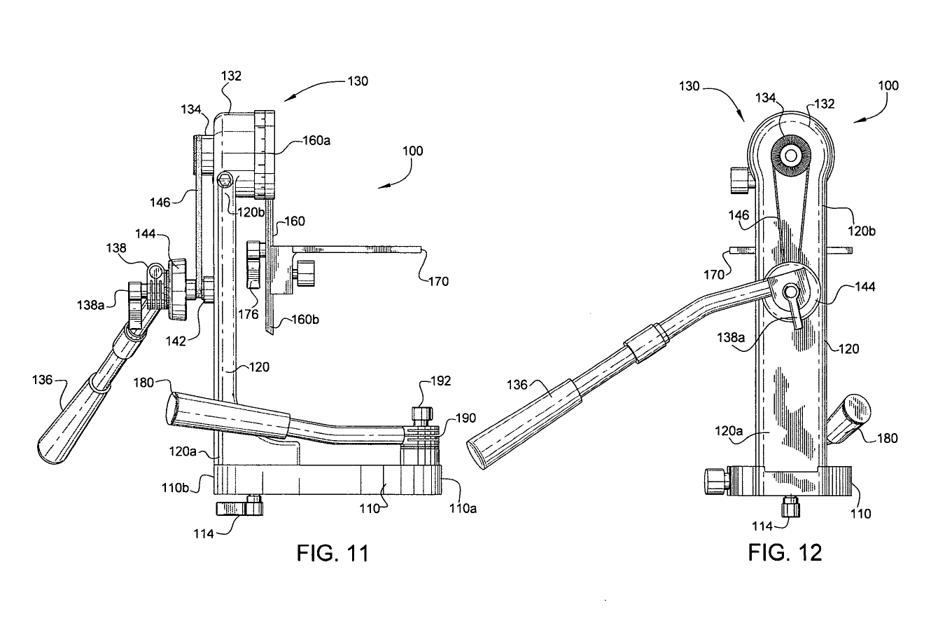

The drive knob 144 is configured so that the pan and tilt handle 136 can be removably attached thereto via the tilt socket lever 148a, as shown in FIGS. 11 and 12. The instrument operator thus has two options: (1) to attach the pan and tilt handle 136 to the tilt shaft 134 for use in the conventional manner and to use the drive knob 144 separately to make fine tilt adjustments or (2) to attach the pan and tilt handle 136 to the drive know 144 and use the pan and tilt handle both to make fine tilt adjustments and to pan.

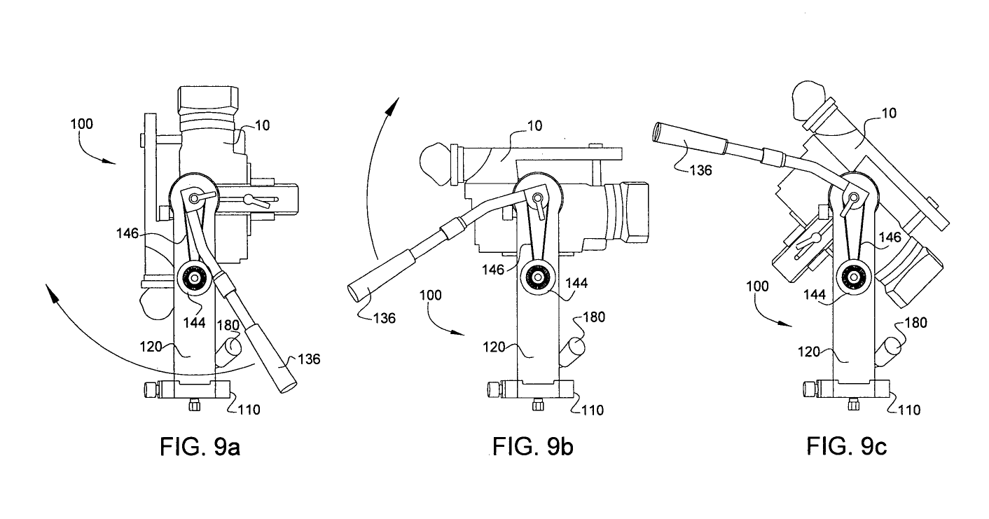

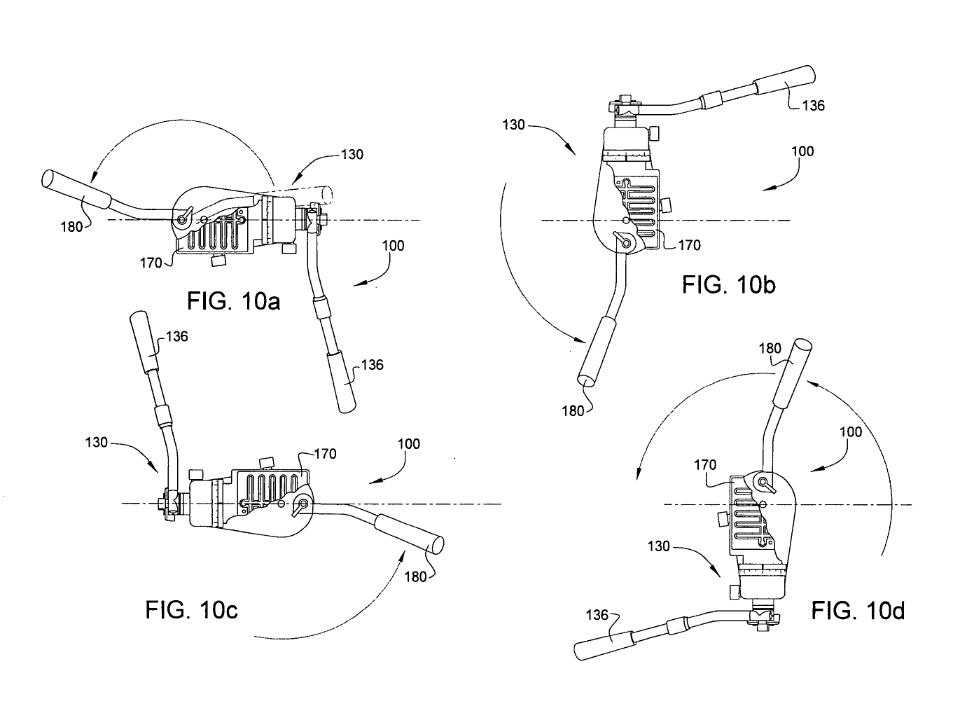

The carrier arm 160 is fixedly mounted at its first end to the second end of the tilt shaft 134 for movement with the tilt shaft 134. In other words, the pan and tilt handle 136 is operatively connected to the instrument platform 170 via the carrier arm 160 and the tilt shaft 134 for tilting the instrument platform 170 in a circular path around a horizontal axis, as shown in FIGS. 9a-9c. The pan and tilt handle 136 also is operatively connected to the base plate 110 via the support column 120 for panning the head 100 on the tripod or jib mount around a vertical axis, as shown in FIGS. 10a-10d. The carrier arm 160 is oriented relative to the tilt shaft 134 such that the plane of rotation of the carrier arm 160 is perpendicular to the rotation axis of the tilt shaft 134.

An auxiliary handle socket 190 with a conventional locking lever or knob 192 (for example, as disclosed with respect to the pan handle arrangement of U.S. Pat. No. 4,621,785) can be affixed to the top surface of the base plate 110 for removably attaching the auxiliary handle 180 to the base plate 110, and for selectively pivoting the auxiliary handle 180 around an axis perpendicular to the base plate 110, between a retracted position in which it rests over the base plate 110 (as shown in FIGS. 1-8, and 9a-9c) and an extended position in which it extends outwardly from the base plate 110 (as shown in FIGS. 10a-10d). When the instrument platform 170 is positioned vertically or nearly vertically with the camera 10 aimed up (as shown in FIG. 9a) or down, the auxiliary handle 180 can be moved by the instrument operator into the extended position to more easily pivot the head 100 on the tripod or jib mount. The auxiliary handle 180 can conveniently be moved to its retracted position when not being used by the instrument operator. The auxiliary handle 180 also can be removed from the auxiliary handle socket 190 by fully loosening the locking lever or knob 192.

A mechanism is provided for mounting the support column 120 to the base plate 110 in a manner that allows for selectively adjusting the position of the support column 120 along an axis between the first and second ends 110a and 110b of the base plate 110. For example, the base plate 110 can be provided with one or more slots or tracks 112 therein, and the first end 120a of the support column 120 can be configured for sliding engagement in the slots or tracks 112, with one or more knobs, spindle grips, or the like 114 for selectively locking the support column 120 in place relative to the base plate 110.

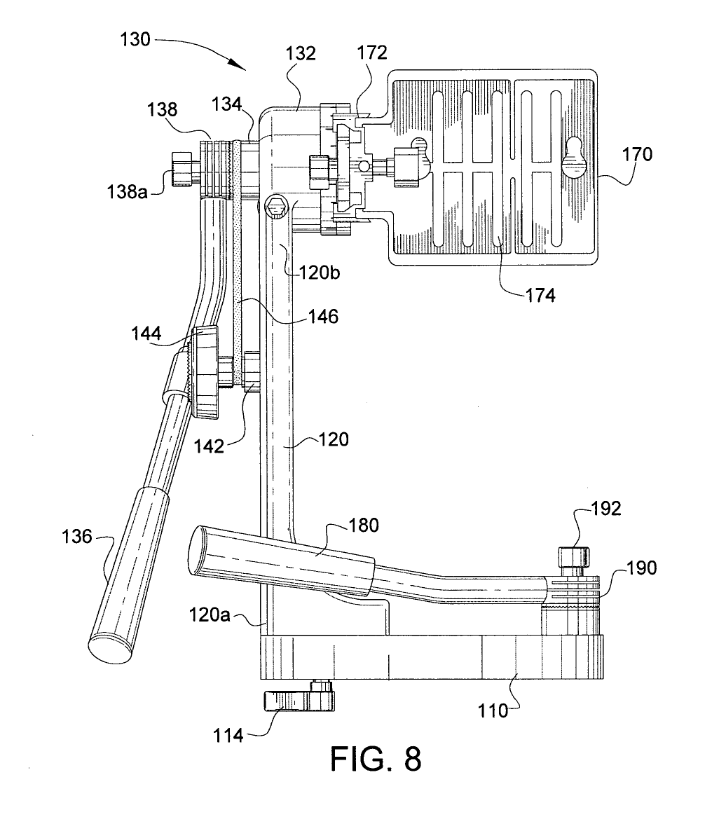

The instrument platform 170 is mounted to the carrier arm 160 in a manner that allows the position of the instrument platform 170 to be selectively adjusted along an axis between the first and second ends of the carrier arm 160. For example, the carrier arm 160 can be provided with an axial slot 162 extending inwardly from the second end 160b, and one end of the instrument platform 170 can be provided with an internally threaded bore (not shown) for receiving the threaded shaft of a knob extending through the slot. Further, the instrument platform 170 can be provided at its end with a groove 172 (FIG. 8) having a profile configured to matingly engage the sides of the carrier arm 160, to further stabilize the instrument platform. However, as will be appreciated by those of skill in the art, any other mechanism can be used that allows for selective adjustment and stabilization of the position of the instrument platform 170 on the carrier arm 160.

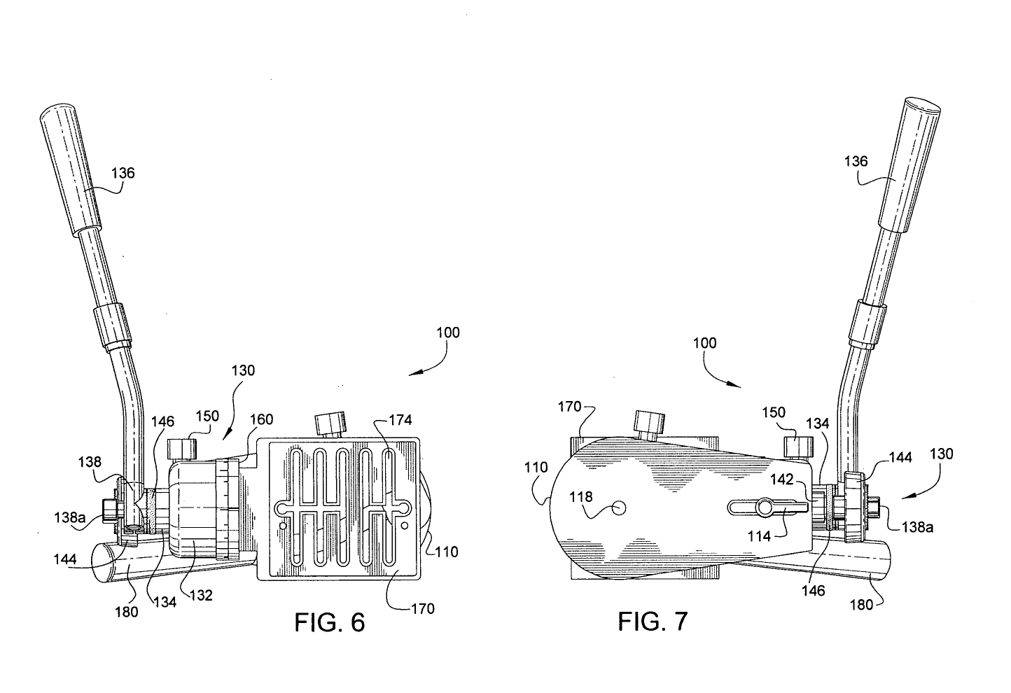

The instrument platform 170 includes means for balancing the instrument's center of gravity. Preferably, the balancing means comprises a plurality of slots or apertures in the instrument platform 170, aligned and positioned to permit the instrument to be attached to the instrument platform 170 (via, for example, a conventional knob) at a point where its center of gravity is balanced. The slots or apertures can be separate, as shown in parent application Ser. No. 29/300,564, or interconnected as best shown in FIGS. 6 and 8, so that the position of the instrument can be adjusted without having to disengage the knob from the instrument.

Modifications and variations of the above-described embodiments of the present invention are possible, as appreciated by those skilled in the art in light of the above teachings. For example, although the invention has been described primarily with respect to a camera, it will be appreciated by those of skill in the art that it can be used with other types of instruments that are commonly mounted on a tripod, and which it is desirable to pan and/or tilt while so mounted. It is therefore to be understood that, within the scope of the appended claims and their equivalents, the invention may be practiced otherwise than as specifically described.

What is claimed is:

1. A head for mounting an instrument on a tripod or jib, comprising:
a base plate having a top surface;
a support column extending vertically from the top surface of the base plate, the support column having a first end attached to the base plate and a second end remote from the base plate;
a tilt shaft rotatably mounted at the second end of the support column;
a carrier arm pivotably mounted to the support column via the tilt shaft;
an instrument platform mounted on the carrier arm; and
a fine control mechanism mounted to the back of the support column and including a rotatable drive shaft and a drive belt operatively connecting the drive shaft to the tilt shaft, the diameter of the drive shaft being smaller than the diameter of the tilt shaft.

2. The head of claim 1, further comprising a pan and tilt handle operatively connected to the tilt shaft for tilting the instrument platform and for panning the head relative to the tripod or jib.

3. The head of claim 2, wherein the fine control mechanism further includes a drive knob mounted at the end of the drive shaft for rotation therewith, the drive knob being configured for removable attachment of the pan and tilt handle thereto.

4. A head for mounting an instrument on a tripod or jib, comprising:
an elongated base plate having first and second ends;
a support column extending vertically from the top surface of the base plate at the second end of the base plate, the support column having a first end attached to the base plate and a second end remote from the base plate;
a tilt shaft rotatably mounted at the top of the support column;
a carrier arm having first and second ends and a longitudinal axis extending between its first and second ends, the carrier arm being pivotably mounted at its first end to the top of the support column via the tilt shaft;
an instrument platform movably mounted on the carrier arm, the position of the instrument platform being adjustable along the axis of the carrier arm, the instrument platform including means for balancing the instrument's center of gravity; and
a fine control mechanism mounted to the back of the support column and including a rotatable drive shaft and a drive belt operatively connecting the drive shaft to the tilt shaft, the diameter of the drive shaft being smaller than the diameter of the tilt shaft.

5. The head of claim 4, further comprising a pan and tilt handle operatively connected to the tilt shaft for tilting the instrument platform and for panning the head relative to the tripod or jib.

6. The head of claim 5, wherein the fine control mechanism further includes a drive knob mounted at the end of the drive shaft for rotation therewith, the drive knob being configured for removable attachment of the pan and tilt handle thereto.
